(19) United States
(12) Patent Application Publication
(10) Pub. No.: US 2024/0370767 A1
(43) Pub. Date: Nov. 7, 2024

(54) TRAINING MACHINE LEARNING MODELS ON PRIVATE DATA IN UNTRUSTED ENVIRONMENT USING ANONYMIZED DATA AND ENCRYPTED DATA

(71) Applicant: International Business Machines Corporation, Armonk, NY (US)

(72) Inventors: Moran BARUCH, Petah Tikva (IL); Nir DRUCKER, Zichron Yaakov (IL); Omri SOCEANU, Haifa (IL)

(21) Appl. No.: 18/311,504

(22) Filed: May 3, 2023

(51) Int. Cl. G06N 20/00

(52) U.S. Cl. CPC G06N 20/00

(57) ABSTRACT

An example system includes a processor to train and stabilize a machine learning model using public data. The processor can fine-tune the machine learning model using anonymized private data. The processor can fine-tune the machine learning model using encrypted private data.

### BACKGROUND

The present techniques relate to training machine learning models. More specifically. the techniques relate to training machine learning models in untrusted environments.

Training machine learning (ML) models such as neural network (NN) models and using them for classifying data are tasks that involve heavy computations. Users who wish to train ML models often prefer to use the cloud instead of maintaining their own infrastructure. Nevertheless, regulations such as the General Data Protection Regulation (GDPR) of the European Union may prevent them from uploading unencrypted confidential information to the cloud.

One way to address such regulations is through using homomorphic encryption (HE), which allows the cloud to perform computations on encrypted data. HE has been demonstrated for example on small machine learning models such as logistic regression. While using HE solves confidentiality problems, it is still considered impractical. In particular, training a machine learning model requires several serial iterations, also referred to as epochs. Some HE schemes support evaluating functions of an unlimited number of epochs but using them to train a neural network model can take weeks. Some other schemes are faster, but they limit the number of training epochs to 1-2 epochs before the plaintext model becomes too noisy to use.

Another way to mitigate the privacy issue is by using an anonymization technique such as deferential privacy, masking, or K-anonymity, before uploading data to the cloud. However, the issue with this anonymization approach is that the anonymization method may lose valuable information that is needed to train the model. Thus, such approaches may end with a biased model with reduced accuracy.

Another method involves splitting the network into several parts, with the first and last layers that contain most of the private data are trained on the client platforms while the middle part of the network is trained on the server. However, training a network in parts requires the client who owns the private data to participate in the training process.

### SUMMARY

According to an embodiment described herein, a system can include processor to train and stabilize a machine learning model using public data. The processor can also further fine-tune the machine learning model using anonymized private data. The processor can also fine-tune the machine learning model using encrypted private data. Thus, the system enables a secure, private, and efficient manner of training machine learning models using encrypted private data. Preferably, the training and fine-tuning is automatically executed without intermediate interaction with a user. In this embodiment, the system is fully automated and thus very efficient. Optionally, the private data is anonymized using k-anonymity. In this embodiment, the private data can be efficiently anonymized. Optionally, the private data is anonymized using blurring. In this embodiment, images in the private data can be efficiently anonymized. Optionally, the private data is anonymized using masking. In this embodiment, the private data can be efficiently anonymized. Optionally, the private data is anonymized using differential privacy. In this embodiment, the private data can be efficiently anonymized. Preferably, the private data is encrypted using homomorphic encryption. In this embodiment, homomorphic operations are enabled. Preferably, the machine learning model is fine-tuned using public data in addition to the anonymized private data and the encrypted private data. In this embodiment, over-fitting the machine learning model on the anonymized private data and the encrypted private data is avoided.

According to another embodiment described herein, a method can include training and stabilizing, via a processor, a machine learning model using public data. The method can further include fine-tuning, via the processor, the machine learning model using anonymized private data. The method can also further include fine-tuning, via the processor, the machine learning model using encrypted private data. Thus, the method enables a secure, private, and efficient manner of training machine learning models using encrypted private data. Preferably, training and stabilizing the machine learning model and fine-tuning the machine learning model is executed automatically without any intermediate interaction with a user. In this embodiment, the method is fully automated and thus very efficient. Optionally, the method includes anonymizing the private data using k-anonymity. Optionally, the method includes anonymizing the private data using blurring. Optionally, the method includes anonymizing the private data using masking. Optionally, the method includes anonymizing the private data using differential privacy. Optionally, the method includes encrypting the private data using homomorphic encryption. Preferably, fine-tuning the machine learning model includes using the public data in addition to the anonymized private data and the encrypted private data. In this embodiment, the method can avoid over-fitting the machine learning model on the anonymized private data and the encrypted private data. Preferably, training and fine-tuning the machine learning model includes training using only user data including the public data and the private data. In this embodiment,

According to another embodiment described herein, a computer program product for training machine learning models can include computer-readable storage medium having program code embodied therewith. The program code executable by a processor to cause the processor to train and stabilize a machine learning model using public data. The program code can also cause the processor to fine-tune the machine learning model using anonymized private data. The program code can also cause the processor to fine-tune the machine learning model using encrypted private data. Thus, the program code enables a secure, private, and efficient manner of training machine learning models using encrypted private data. Optionally, the program code can also cause the processor to anonymize the private data using k-anonymity, blurring, masking, or using differential privacy. In these embodiments, the private data may be efficiently automatically anonymized. Preferably, the program code can also cause the processor to encrypt the private data using homomorphic encryption. In this embodiment, homomorphic operations are enabled.

### BRIEF DESCRIPTION OF THE SEVERAL VIEWS OF THE DRAWINGS

FIG. 1 is a block diagram of an example computing environment that contains an example of an environment for the execution of at least some of the computer code involved in performing the inventive methods, such as a privacy-preserving trainer module;

FIG. 2 is an example tangible, non-transitory computer-readable medium that can train machine learning models on private data in an untrusted environment;

FIG. 3 is a process flow diagram of an example method that can train machine learning models on private data in an untrusted environment;

FIG. 4 is a block diagram of an example system for training machine learning models on private data in an untrusted environment;

FIG. 5A shows example training and validation graphs of accuracy over epochs of training the above experiment;

FIG. 5B shows example training and validation graphs of loss over epochs of training in the experiment;

FIG. 6A shows example training and validation graphs of accuracy over epochs of the continued training the above experiment; and

FIG. 6B shows example training and validation graphs of loss over epochs of continued training in the experiment.

### DETAILED DESCRIPTION

According to embodiments of the present disclosure, example system includes a processor to train and stabilize a machine learning (ML) model using public data. The processor can fine-tune the machine learning model using anonymized private data. The processor can fine-tune the machine learning model using encrypted private data. An example three step training method includes using public data to train and stabilize an ML model. The method includes using anonymized private data to fine-tune the model by training it for several more epochs. For privacy reasons, the original private data is anonymized using anonymization or pseudo-anonymization or masking techniques such as K-anonymity, blurring, masking, or differential privacy. While this step often improves the accuracy of a generic model, the fine-tuned model might still be far from perfect due to the anonymization. The method thus further includes using encrypted private data to further fine-tune the model. For example, the model is trained for an additional small number of epochs (typically 1-4) on the data encrypted under homomorphic encryption (HE). This step trains the model directly on the confidential data and thus yields the most accurate results. Thus, embodiments of the present disclosure provide techniques for efficiently and accurately training a machine learning (ML) model on private data in an untrusted environment such as the cloud. The embodiments thus enable fine-tuning a model in the cloud over private data and not just inaccurate differential privacy (DP) data. In particular, the embodiments described herein shorten the length of the training stage when training over encrypted data. In various embodiments, the techniques described herein utilize the full power of FHE by having a better training starting point than without using DP. Moreover, the embodiments provide a fully automated process.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as a privacy-preserving trainer module 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

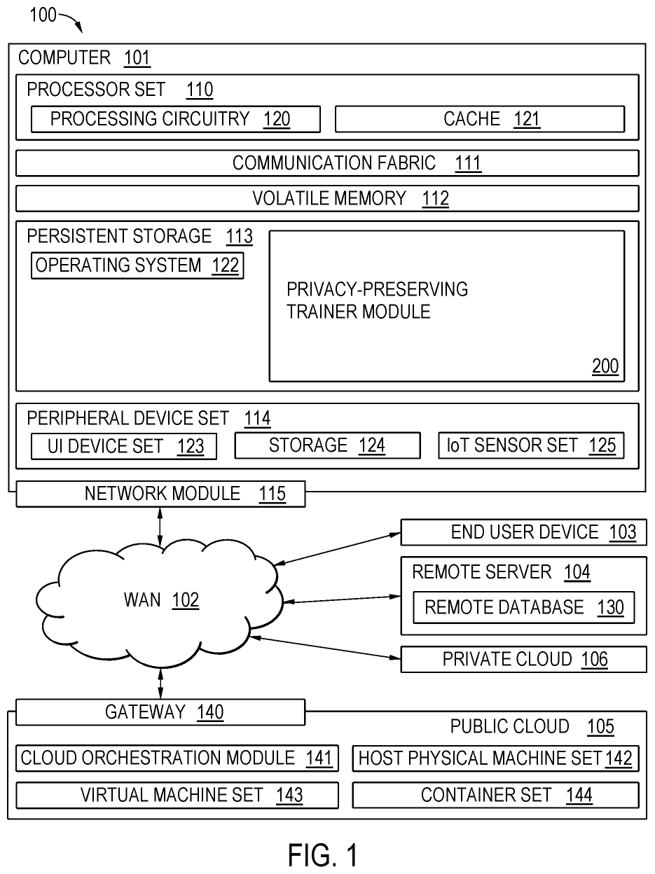

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

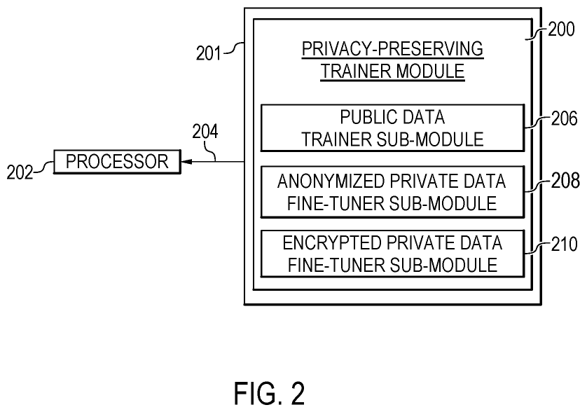

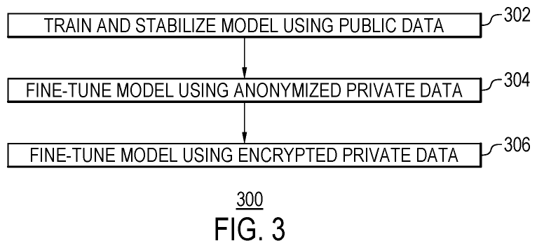

Referring now to FIG. 2, a block diagram is depicted of an example tangible, non-transitory computer-readable medium 201 that can train machine learning models on private data in an untrusted environment. The tangible, non-transitory, computer-readable medium 201 may be accessed by a processor 202 over a computer interconnect 204. Furthermore, the tangible, non-transitory, computer-readable medium 201 may include code to direct the processor 202 to perform the operations of the method 300 of FIG. 3.

The various software components discussed herein may be stored on the tangible, non-transitory, computer-readable medium 201, as indicated in FIG. 2. For example, the privacy-preserving trainer module 200 includes a public data trainer sub-module 206 that includes code to train and stabilize a machine learning model using public data. The privacy-preserving trainer module 200 includes an anonymized private data fine-tuner sub-module 208 that includes code to fine-tune the machine learning model using anonymized private data. In some examples, the anonymized private data fine-tuner sub-module 208 further includes code to anonymize the private data using k-anonymity. In some examples, the anonymized private data fine-tuner sub-module 208 also includes code to anonymize the private data using blurring. In some examples, the anonymized private data fine-tuner sub-module 208 includes code to anonymize the private data using masking. In some examples, the anonymized private data fine-tuner sub-module 208 includes code to anonymize the private data using differential privacy. In some examples, the model is fine-tuned using the public data in addition to the anonymized private data. For example, a substantially smaller partial subset of the public data may be used in addition to the anonymized private data. The privacy-preserving trainer module 200 includes an encrypted private data fine-tuner sub-module 210 that includes code to fine-tune the machine learning model using encrypted private data. In various examples, the encrypted private data fine-tuner sub-module 210 also includes code to encrypt the private data using homomorphic encryption. For example, the encrypted private data fine-tuner sub-module 210 also includes code to encrypt the private data using fully homomorphic encryption. In some examples, the model is fine-tuned using the public data in addition to the encrypted private data. For example, a substantially smaller partial subset of the public data may be used in addition to the encrypted private data.

It is to be understood that any number of additional software components not shown in FIG. 2 may be included within the tangible, non-transitory, computer-readable medium 201, depending on the specific application. For example, an inference sub-module may also be included within the tangible, non-transitory, computer-readable medium 201. The inference sub-module may include code for executing an inference stage on the fine-tuned machine learning model.

FIG. 3 is a process flow diagram of an example method that can train machine learning models on private data in an untrusted environment. The method 300 can be implemented with any suitable computing device, such as the computer 101 of FIG. 1. For example, the methods described below can be implemented by the processor set 110 of FIG. 1.

At block 302, a model is trained and stabilized using public data. For example, the public data may be from a large publicly available dataset, such as Imagenet. The publicly available data may be data that is generally related to a task to be executed using the trained model. For example, if the task is to detect cancer in medical images, then the publicly available data may be images of cancer that do not include any private information that may connect the images with any particular individuals. In various examples, the model may be any suitable machine learning model, such as a neural network, logistic regression, or a linear regression model. In various examples, the model may be detected as stabilized based on accuracy values of the resulting trained network.

At block 304, the model is fine-tuned using anonymized private data. In some examples, the model is fine-tuned using the public data in addition to the anonymized private data. For example, a substantially smaller partial subset of the public data may be used in addition to the anonymized private data. In some examples, the private data may be data subject to one or more regulations or privacy restrictions. In various examples, the private data may be from one or more sources. As one example, the private data may be specific images of identifiable individuals, or individual information such as addresses, names, etc. In various examples, the private data may be anonymized using k-anonymity, blurring, masking, or differential privacy. For example, in using k-anonymity, a data scientist may first examine the dataset and decide if each attribute (column) is an identifier (identifying), a non-identifier (not-identifying), or a quasi-identifier (somewhat identifying). Identifiers such as names are suppressed, non-identifying values are allowed to remain, and the quasi-identifiers need to be processed so that every distinct combination of quasi-identifiers designates at least k records. Two common methods for achieving k-anonymity for some value of k include suppression and generalization. In suppression, certain values of the attributes are replaced by an asterisk ‘*’. All or some values of a column may be replaced by ‘*’. In the anonymized table below, all the values in the ‘Name’ attribute and all the values in the ‘Religion’ attribute have been replaced with a ‘*’. In generalization, individual values of attributes are replaced with a broader category. For example, the value ‘19’ of the attribute ‘Age’ may be replaced by ‘≤20’, the value ‘23’ by ‘20<Age≤30’, etc. Differential privacy (DP) is a system for publicly sharing information about a dataset by describing the patterns of groups within the dataset while withholding information about individuals in the dataset. The idea behind differential privacy is that if the effect of making an arbitrary single substitution in the database is small enough, the query result cannot be used to infer much about any single individual, and therefore provides privacy. In various examples, the DP method used may be a Laplace mechanism, randomized response, or a stable transformation. In various examples, blurring may include using any method to obscure individually identifiable details in data such as sounds or images, such as faces, etc. Masking may alternatively or additionally be used to completely cover portions of data or images.

At block 306, the model is fine-tuned using encrypted private data. In some examples, the model is fine-tuned using the public data in addition to the encrypted private data. For example, a substantially smaller partial subset of the public data may be used in addition to the encrypted private data. In various examples, the private data may be encrypted using homomorphic encryption. For example, the private data may be encrypted using fully homomorphic encryption.

In various examples, the method 300 can include any suitable number of additional operations. For example, the method may include receiving input data and executing inference on the input data via the fine-tuned model. In various examples, training and stabilizing the machine learning model and fine-tuning the machine learning model in blocks 302-306 is executed automatically without any intermediate interaction with a user.

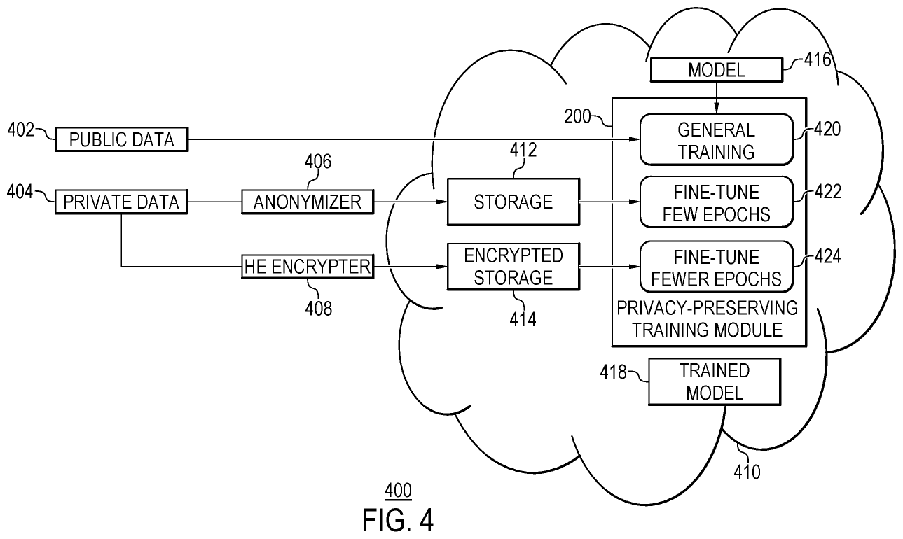

With reference now to FIG. 4, a block diagram shows an example system for training machine learning models on private data in an untrusted environment. The example system 400 of FIG. 4 includes a set of public data 402 and private data 404. The system 400 includes an anonymizer 406 and a homomorphic encryption (HE) encrypted 408 communicatively coupled to one or more databases (not shown) to receive the private data 404. The system 400 also includes a cloud 410. The cloud 410 includes storage 412 and encrypted storage 414, communicatively coupled to the anonymizer 406 and the HE encrypter 408, respectively. For example, the encrypted storage 414 may be encrypted using homomorphic encryption. The cloud 410 includes a model 406. For example, the model 406 may be a machine learning model. The cloud 410 includes a privacy-preserving trainer module 200. The privacy-preserving trainer module 200 is shown receiving a model 416 and generating a trained model 418. For example, the trained model 418 is a machine learning model. In various examples, training and stabilizing the machine learning model and fine-tuning the machine learning model is executed automatically without any intermediate interaction with a user.

Training over encrypted data takes more time than training over cleartext data. The more information used during training the better the accuracy of the final trained model. Some information is considered private and so one is restricted from using it in certain settings in the clear. Following these assumptions, the system 400 can initially train a model over a redacted dataset in the clear. For example, the information can be redacted through blurring, anonymization techniques, down-sampling, nullification of certain segments of data, use of a public dataset, etc. The system 400 can then then fine-tune the model by training over an encrypted dataset with high-resolution, information-rich, original data. The underlying assumption is that the final stage would require fewer epochs to converge than training over the same dataset from the beginning. Three sequential training steps may thus occur on an untrusted environment, such as the cloud 410.

At block 420, the privacy-preserving trainer module 200 executes a general training using the public data 402. For example, the privacy-preserving trainer module 200 can use public data to train and stabilize the model 416.

At block 422, the privacy-preserving trainer module 200 executes a fine-tuning for a few epochs on anonymized private data from the storage 412. For example, the privacy-preserving trainer module 200 can use anonymous private data to fine-tune the model by training the model 416 for several more epochs. In various examples, for privacy reasons, the original data is manipulated using anonymization techniques. In various examples, the anonymizer 406 can anonymize the private data using any suitable anonymization technique. In various examples, the anonymization techniques may include K-anonymity, blurring, masking, or differential privacy, among other suitable techniques. While this step often improves the accuracy of a generic model, the model might still be far from perfect due to anonymization. Thus, another fine-tuning may be executed at block 424.

At block 424, the privacy-preserving trainer module 200 executes a fine-tuning for a small number of epochs on encrypted private data from the storage 414. In some examples, the fine-tuning on encrypted private data may be executed for one to four epochs. This step trains the model directly on the confidential data and thus yields the most accurate results.

As one specific example of the embodiments described herein, country regulations may prevent sending high-resolution camera feeds to an off-premise location. However, the regulations might only allow for a lower resolution, blurred version of the video to be sent to another server. Thus, a company that would like to use the cloud 410 for training a model 416, may start by training the model 416 on public data 402, which may be publicly available image datasets such as Imagenet. Subsequently, the company uploads a masked version of its images to the storage 412 of cloud 410 and continues to train the model 416 on these images at block 422. Once the model reaches a good level of accuracy, the company encrypts the same images using FHE and uploads them to the encrypted storage 414 of cloud 410. The privacy-preserving trainer module 200 can now perform the last 1-2 training epochs on this encrypted data at block 424. The resulting trained model 418 can then be used by the company.

Another specific example of the embodiments described herein follows the scenario above. For example, some countries may prohibit taking and storing satellite images of some of their territories to avoid unwanted collection of information. However, to train a model 418 that is also familiar with these territories, the company may use the same above method. The benefit of the techniques described herein is that they allow achieving a finer model than with previous methods. As mentioned above, only using FHE is either impractical or limited, while only using some anonymization techniques will not get to the same accuracy because some data is lost.

It is to be understood that the block diagram of FIG. 4 is not intended to indicate that the system 400 is to include all of the components shown in FIG. 4. Rather, the system 400 can include fewer or additional components not illustrated in FIG. 4 (e.g., additional storage, or additional data sources, clouds, models, etc.).

In one particular experiment, the CIFAR10 dataset was used. A demi Visual Geometry Group (VGG) type deep convolutional neural network (CNN) was used for this experiment, with Batchnorm and Dropout. The network was made of three “blocks”, each made of two convolution layers (one that increases the number of channels, and another that leave it the same), and a max-pooling afterward. After this, three fully connected layers were included. This model achieved 85-90% accuracy on its own. Then the following process was done: First, the CIFAR10 dataset was split into two distinct sets—one had the images of the classes [‘dog’, ‘car’, ‘plane’], called the “private set”, and the other set had the other classes ([‘bird’, ‘cat’, ‘deer’, ‘frog’, ‘horse’, ‘ship’, ‘truck’]), called the “public set”. The sets were distinct, meaning every image was in only one of them. The classes were chosen such that each class in the private set had a similar class in the public set (dog-cat, car-truck, plane-ship). The model was trained for 20 epochs with Adam optimizer and a learning rate of 0.001 only on the “public set”.

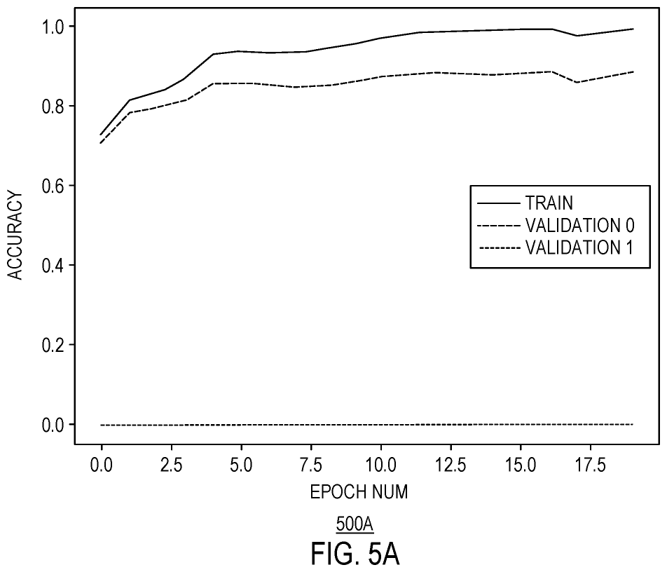

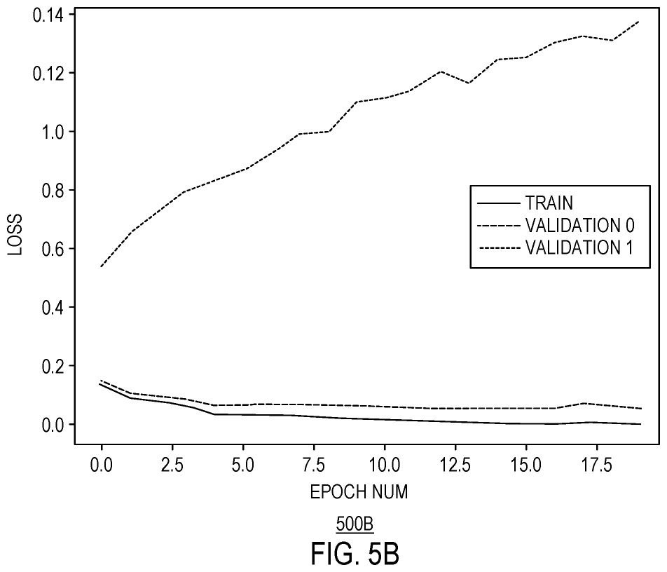

FIG. 5A shows example training and validation graphs of accuracy over epochs of training the above experiment. FIG. 5B shows example training and validation graphs of loss over epochs of training in the experiment. In the graphs 500A and 500B, the blue line is the train set accuracy/loss, the orange one is the “public set” validation accuracy/loss, and the green line is the “private data” validation accuracy/loss. As shown in 500A, the test accuracy for the “private set” was 0% (since the model didn't see any image from this set), and for the “public set” was 87.97%.

In the above experiment, training was continued of the same model over a new training set, which was composed of the “public set” and a noisy “private set”—images from the private set with an added noise from a normal distribution with a standard deviation of 0.5 (after adding the noise, the image was clipped to be in the range [0,1]).

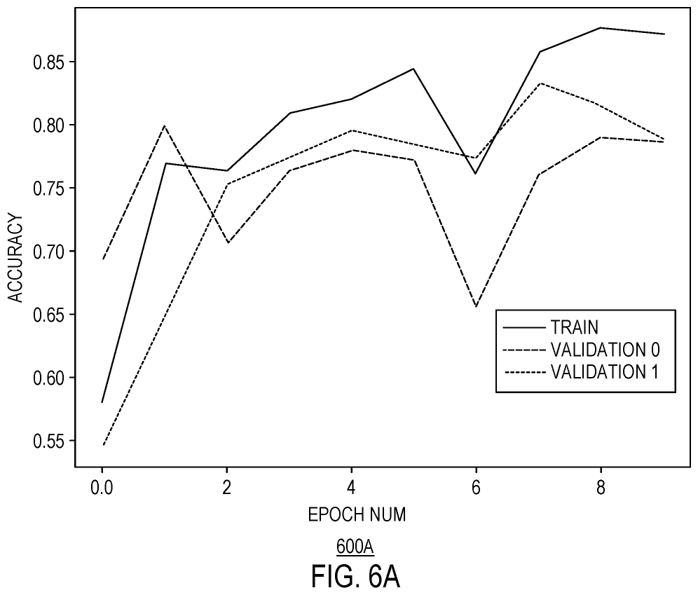

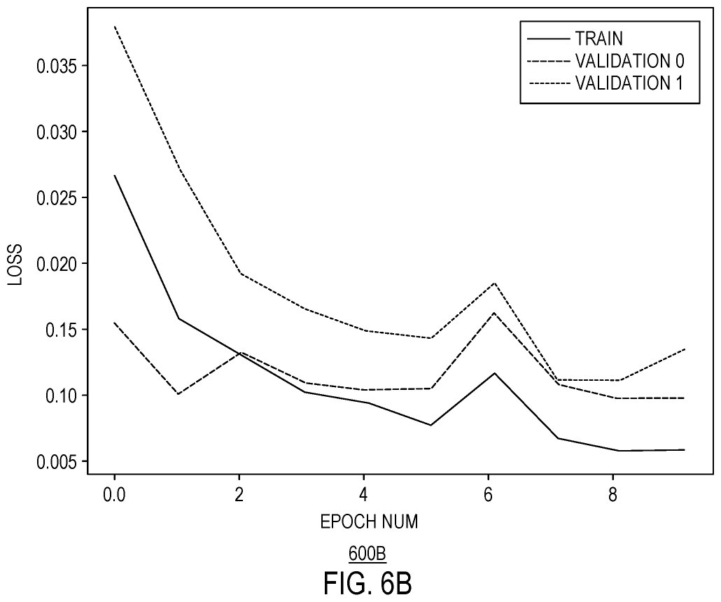

FIGS. 6A and 6B show example graphs 600A and 600B of the results of the continued training. FIG. 6A shows example training and validation graphs of accuracy over epochs of the continued training the above experiment. FIG. 6B shows example training and validation graphs of loss over epochs of continued training in the experiment. The dashed lines indicate the same as in FIGS. 5A and 5B. Note the validation set was without noise. As seen in FIGS. 6A and 6B, the continued training achieved a test accuracy of 78.97% for the “private” set, and an accuracy of 87.83% for the “public” set. The model was then trained for another two epochs with the full set (both the “private” and the “public”, without noise). With this fine-tuning, the model reached an accuracy of 86.4% in the “private” dataset, and 87.4% in the “public” dataset.

The descriptions of the various embodiments of the present techniques have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system, comprising a processor to:
train and stabilize a machine learning model using public data;
fine-tune the machine learning model using anonymized private data; and
fine-tune the machine learning model using encrypted private data.

2. The system of claim 1, wherein the training and fine-tuning is automatically executed without intermediate interaction with a user.

3. The system of claim 1, wherein the private data is anonymized using k-anonymity.

4. The system of claim 1, wherein the private data is anonymized using blurring.

5. The system of claim 1, wherein the private data is anonymized using masking.

6. The system of claim 1, wherein the private data is anonymized using differential privacy.

7. The system of claim 1, wherein the private data is encrypted using homomorphic encryption.

8. The system of claim 1, wherein the machine learning model is fine-tuned using public data in addition to the anonymized private data and the encrypted private data.

9. A computer-implemented method, comprising:
training and stabilizing, via a processor, a machine learning model using public data;
fine-tuning, via the processor, the machine learning model using anonymized private data; and
fine-tuning, via the processor, the machine learning model using encrypted private data.

10. The computer-implemented method of claim 9, wherein training and stabilizing the machine learning model and fine-tuning the machine learning model is executed automatically without any intermediate interaction with a user.

11. The computer-implemented method of claim 9, comprising anonymizing the private data using k-anonymity.

12. The computer-implemented method of claim 9, comprising anonymizing the private data using blurring.

13. The computer-implemented method of claim 9, comprising anonymizing the private data using masking.

14. The computer-implemented method of claim 9, comprising anonymizing the private data using differential privacy.

15. The computer-implemented method of claim 9, comprising encrypting the private data using homomorphic encryption.

16. The computer-implemented method of claim 9, wherein fine-tuning the machine learning model comprises using the public data in addition to the anonymized private data and the encrypted private data.

17. The computer-implemented method of claim 9, wherein training and fine-tuning the machine learning model comprises training using only user data comprising the public data and the private data.

18. A computer program product for training machine learning models, the computer program product comprising a computer-readable storage medium having program code embodied therewith, the program code executable by a processor to cause the processor to:
train and stabilize a machine learning model using public data;
fine-tune the machine learning model using anonymized private data; and
fine-tune the machine learning model using encrypted private data.

19. The computer program product of claim 18, further comprising program code executable by the processor to anonymize the private data using k-anonymity, blurring, masking, or using differential privacy.

20. The computer program product of claim 18, further comprising program code executable by the processor to encrypt the private data using homomorphic encryption.
